(19) United States
(12) Patent Application Publication
(10) Pub. No.: US 2017/0059263 A1
(43) Pub. Date: Mar. 2, 2017

(54) SONIC DUST REMEDIATION

(71) Applicants: Yanbing SUN, Shanghai (CN); Mark MACDONALD, Beaverton, OR (US); Jiancheng TAO, Shanghai (CN); Intel Corporation, Santa Clara, CA (US)

(72) Inventors: Yanbing Sun, Shanghai (CN); Mark MacDonald, Beaverton, OR (US); Jiancheng Tao, Shanghai (CN); Ming Zhang, Shanghai (CN)

(73) Assignee: Intel Corporation, Santa Clara, CA (US)

(21) Appl. No.: 15/122,424

(22) PCT Filed: Mar. 31, 2014
(86) PCT No.: PCT/CN2014/074353

§ 371 Date: Aug. 30, 2016

(51) Int. Cl. F28G 7/00; F28G 15/00; B08B 7/02; G05B 15/02; G06F 1/20

(52) U.S. Cl. CPC F28G 7/00; G05B 15/02; G06F 1/203; B08B 7/026; F28G 15/003

(57) ABSTRACT

A system and method are disclosed for using a sonic frequency to induce a vibration useful for clearing dust accumulation from microelectronics, such as a laptop computer. A speaker driver may be mounted onto a support structure for a heat exchanger (220). At an advantageous time, such as boot up, a sonic frequency may be driven onto the speaker (250), thus inducing vibration in the heat exchanger (220) and helping to clear dust accumulation. In some cases, a resonant frequency may be used to optimize the amount of vibration per unit power delivery.

### FIELD OF THE DISCLOSURE

This application relates to the field of electronics, and more particularly to a system and method for sonic remediation of dust accumulation.

### BACKGROUND

Cooling and heat exchange are among the numerous issues that a microelectronics designer may need to deal with in designing usable and reliable systems. In particular in the field of computing devices, as feature size decreases, the amount of power drawn by an integrated circuit can increase dramatically.

### BRIEF DESCRIPTION OF THE DRAWINGS

The present disclosure is best understood from the following detailed description when read with the accompanying figures. Various features may be shown to a certain scale by way of non-limiting example, where physical scale is appropriate and logical. However, in other embodiments, dimensions of the various features may be arbitrarily increased or decreased as necessary.

FIG. 1 is a bottom view of a computer according to one or more examples of the present Specification.

FIG. 2 is a cutaway view of a computer showing certain internal arrangements according to one or more examples of the present Specification.

FIG. 3 is a block diagram of a sonic dust remediation system according to one or more examples of the present Specification.

FIG. 4 is a block diagram of a computer according to one or more examples of the present Specification.

FIG. 5 is a flow chart of an example method of performing sonic dust removal according to one or more examples of the present Specification.

FIG. 6 is a block diagram of an example method of performing a frequency sweep according to one or more examples of the present Specification.

### DETAILED DESCRIPTION OF THE EMBODIMENTS

### Overview

In an example, a system and method are disclosed for using a sonic frequency to induce a vibration useful for clearing dust accumulation from microelectronics such as a laptop computer. A speaker driver may be mounted onto a support structure for a heat exchanger, or may be mounted to a rigid or semi-rigid connecting member that mechanically interfaces to the heat exchanger. At an advantageous time, such as bootup, a sonic frequency may be driven onto the speaker, thus inducing vibration in the heat exchanger and helping to clear dust accumulation. In some cases, a resonant frequency may be used to optimize the amount of vibration per unit power delivery. Because real-world systems are not ideal point masses, an approximate resonant frequency may be calculated or stored. At a selected time, a frequency sweep may be run on the speaker, and sensors on a motherboard used to measure vibration. A peak vibration point may be selected as the new resonant frequency and used until the next frequency sweep.

### Example Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed in different figures.

Different embodiments many have different advantages, and no particular advantage is necessarily required of any embodiment.

As microelectronic feature sizes continue to trend ever smaller, power dissipation, and especially heat dissipation, become a major concern. Excessive heat can damage sensitive electronic components, warp mountings, and otherwise cause problems within systems.

To remove heat from sensitive components, many modern computing devices include a species of heat exchanger and fan. The heat exchanger may include thermally conductive material, such as a metal mounting, that draws heat from a chip and conducts it into an array of air-cooled metal blades that dissipate heat into the ambient environment. Heat dissipation may be assisted by a fan, which circulates cooler air across the heat sink, thereby promoting cooling.

The rate of heat dissipation may be represented by the following equation:

$${q}_{k} = - kA \frac{d T}{d x}$$

Herein, qₖ is the rate of heat dissipation. A is the cross-sectional area over which the heat is distributed in the heat sink, and

$$\frac{d T}{d x}$$

is the temperature gradient. Evidently, any decrease in the cross-sectional area will cause a directly corresponding reduction in heat dissipation. This can be problematic in some computing systems if dust and other debris build up between blades of the heat sink, reducing the cross-sectional area of air flow. Heat may increase, endangering electronics. To compensate, a processor may need to throttle back its processing speed, negatively affecting system performance. System acoustic noise may also increase.

It is recognized in this Specification that driving an acoustic waveform onto a mechanical mounting of the heat sink may induce mechanical vibrations, thereby substantially dislodging dust and debris accumulation. The frequency of this acoustic signal may be, in one example, at or near a mechanical resonance so that maximum vibration is realized with minimal acoustical power output.

Advantageously, many computers, such as laptop computers, already include speakers suitable for driving such acoustic waveforms. With minimal physical modification, namely providing a rigid or semi-rigid mounting between the speaker and the heat sink, acoustic vibrations from the speaker may be translated into mechanical vibrations sufficient to dislodge accumulated dust from the heat sink. The fan may also be operated at its peak speed during this operation to impel dislodged dust and debris outward.

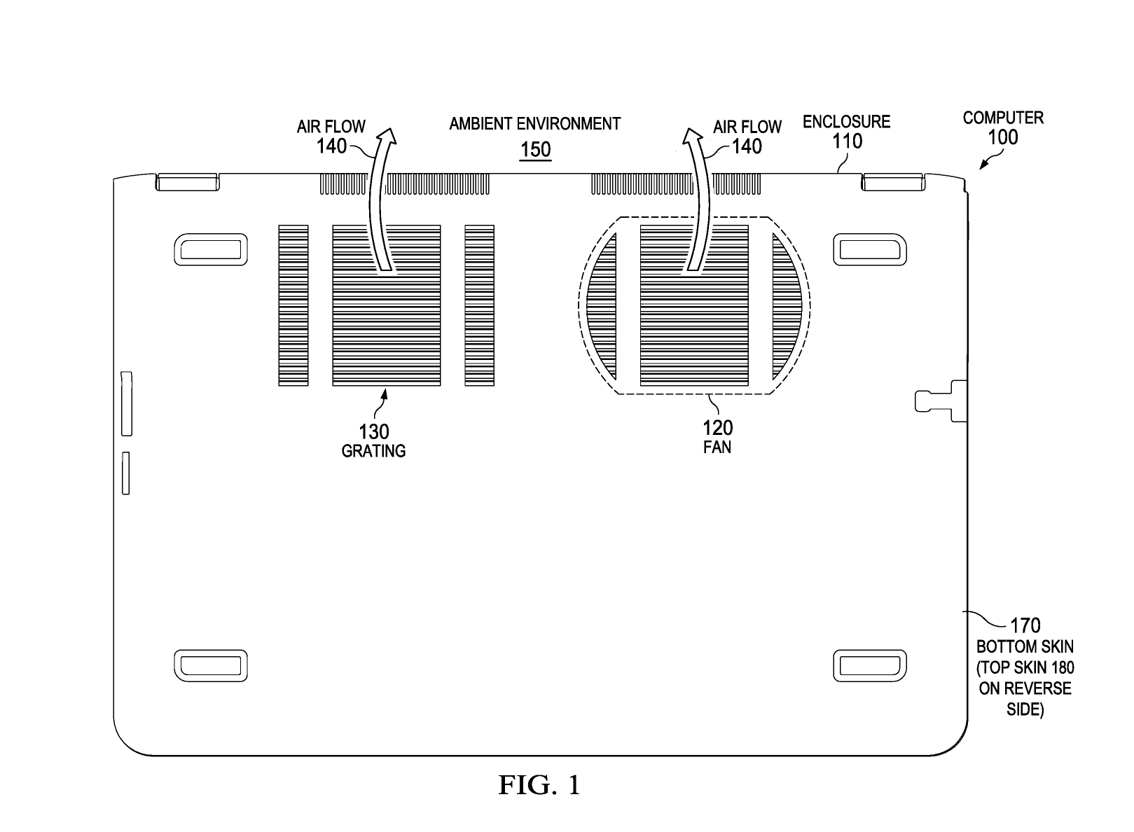

FIG. 1 is a bottom view of a computer 100 according to one or more examples of the present Specification. By way of example, computer 100 is disclosed as a laptop computer. It should be noted however that many types of computers are possible, and this Specification should not be construed as limited to a laptop computer, or any particular form factor or design of computer 100 as shown in this drawing. In particular, the teachings of this Specification may be applicable to many types of heat-sensitive microelectronics, including many types of computing devices. It should thus be recognized that computer 100 is disclosed only as an example to facilitate discussion.

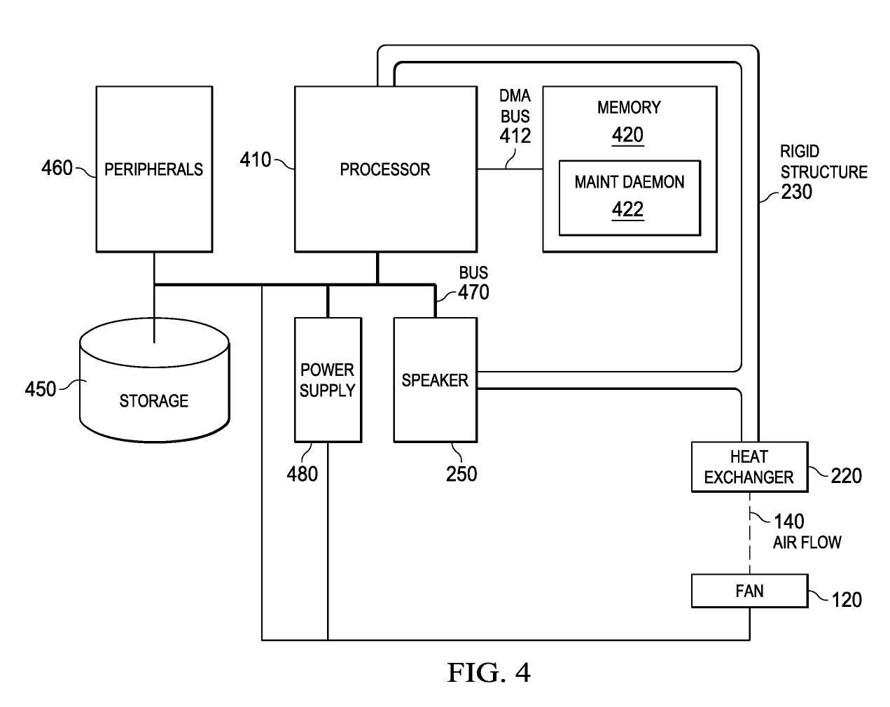

Computer 100 in this example is a laptop form factor, including an enclosure 110 providing outer casing for computer 100. Enclosure 110 includes a bottom skin 170. Enclosure 110 also includes sides (not shown) and a top skin 180 on a reverse side of enclosure 110 from bottom skin 170. Additional functional blocks within computer 100 are disclosed by way of example in FIG. 4. Operation of computer 100 may generate heat, for example from a processor or other components included within enclosure 110. Because heat is undesirable for many electronic components, one or more fans 120 may be provided to expel heat away from sensitive electronic components. One or more gratings 130 may also be disposed within bottom skin 170 to facilitate heat exchange from within enclosure 110 to ambient environment 150.

It is desirable to expel heat from enclosure 110 out to ambient environment 150. To facilitate expulsion of heat, enclosure 110 may include one or more gratings 130, which are configured to allow fluid air exchange between the interior of enclosure 110 and ambient environment 150. As seen in this example, an airflow 140 is illustrated, flowing from within enclosure 110 out to ambient environment 150.

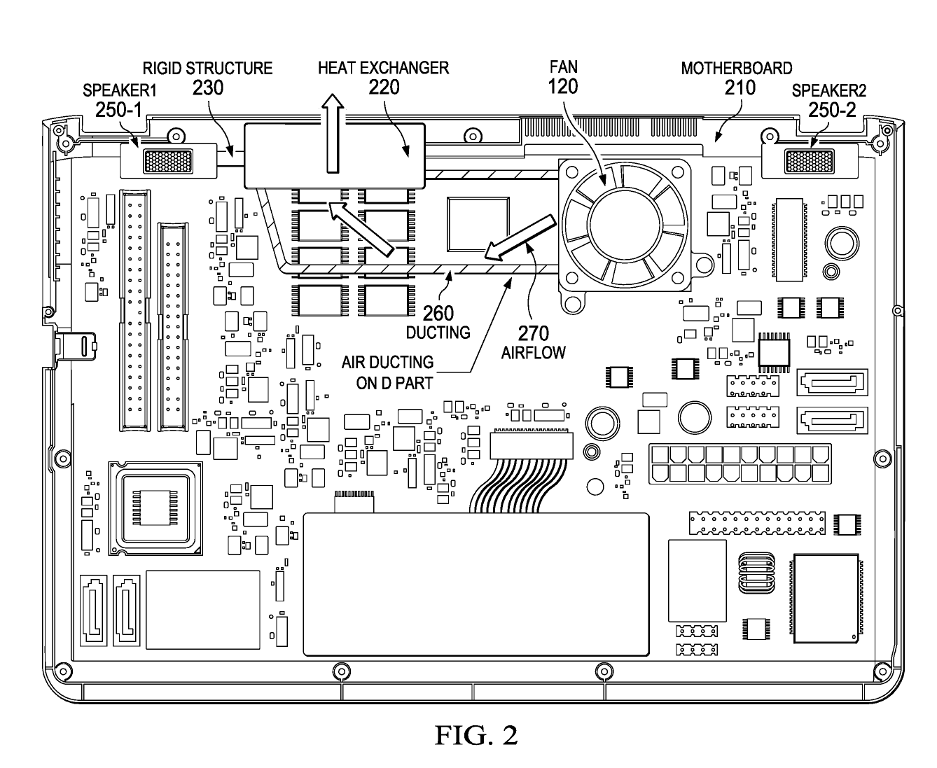

FIG. 2 is a cutaway view of computer 100 showing certain internal arrangements according to one or more examples of the present Specification. In this example, computer 100 includes a motherboard 210 that may be operable to receive and communicatively and new.

In this example, computer 100 includes a motherboard 210, which may be operable to receive and to communicatively, mechanically, and thermally couple certain select complements of computer 100. In particular, computer 100 may include a processor 410, which in this view is at least partially obscured by fan 120 but which is shown in FIG. 4. Processor 410 contains the primary intelligence for computer 100. According to contemporary design practices, processor 410 may draw a significant volume of power, some of which is converted into heat. It is therefore desirable to direct heat away from processor 410 and to expel the heat to ambient environment 150. To this end, various heat redirection techniques may be used, including heat sinks, thermal paste, air cooling, liquid cooling, and other similar techniques by way of nonlimiting example. In this particular example, a heat exchanger 220 is provided, which includes metallic blades. It should be noted that a “heat exchanger” is a term of art in the field of this Specification, and that it is intended herein that the term “heat exchanger” have the ordinary definition of a heat exchanger in the computer arts.

Heat exchanger 220 may be thermally coupled to processor 410 via a heat conductor 280. Heat conductor 280 may also be enclosed within ducting 260. Ducting 260 may be provided to direct heated airflow 140 from processor 410 to ambient environment 150. To drive airflow 140, a fan 120 may be provided, with its direction of airflow being the same as airflow 140. Thus, heat is conducted away from processor 410 by heat conductor 280 to heat exchanger 220. Furthermore, because air around processor 410 becomes heated, heated air may be directed by fan 120 through conduit 260 to heat exchanger 220. Airflow 140 then directs heated air out of enclosure 210 to ambient environment 150.

In this example, there is also provided two speakers 250, speaker one 250-1 and speaker two 250-2. Speakers 250 are provided as non-limiting examples of mechanical drivers, and it should be appreciated that other types of mechanical drivers may be used in place of speakers 250. Speaker one 250-1 is connected in this example to heat exchanger 220. In particular, a rigid structure 230 is provided to mechanically couple speaker one 250-1 to heat exchanger 220, or to a supporting structure of heat exchanger 220. Rigid structure 230 may be an example or a species of an acoustic energy transfer element disposed to translate at least part of the acoustic energy provided by a speaker 250 into a mechanical waveform on heat exchanger 220. Advantageously, if dust becomes built up within grating 130, or otherwise within heat exchanger 220, speaker one 250-1 may be used to drive an acoustic frequency onto rigid structure 230. Rigid structure 230 may then translate the acoustic frequency of speaker 250 into a mechanical waveform that is imposed upon heat exchanger 220. Thus, heat exchanger 220 vibrates, dislodging dust.

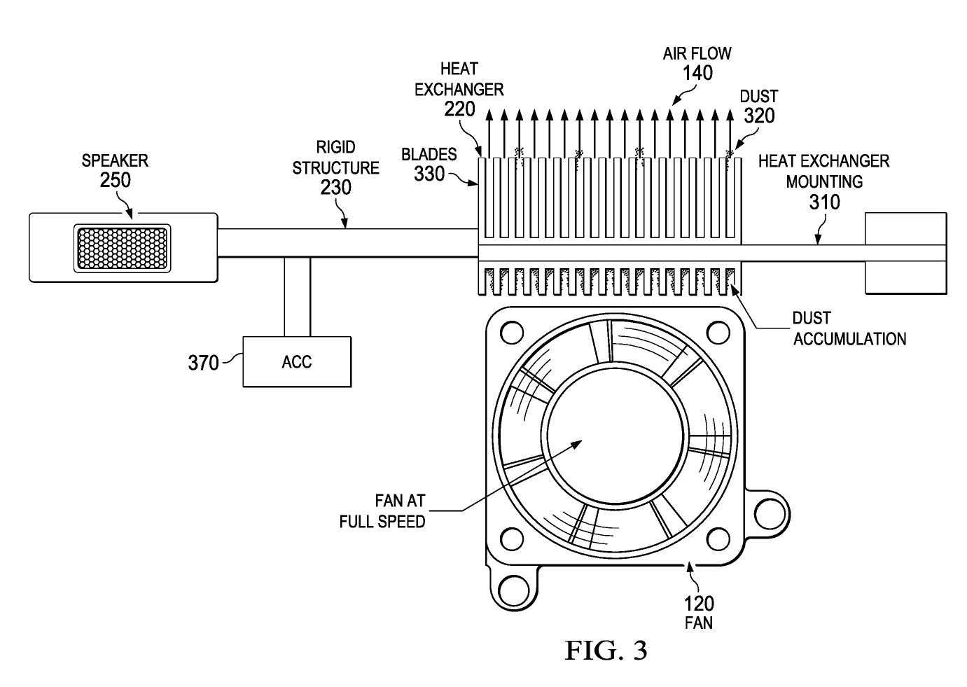

FIG. 3 is a block diagram of a sonic dust remediation system 300 according to one or more examples of the present Specification. It should be noted that in this present example, sonic dust remediation system 300 is provided with computer 100. However, it is intended that the teachings of sonic dust remediation system 300 be applicable to any suitable system, and in particular microelectronic systems that may benefit from the teachings disclosed herein. In this example, sonic dust remediation system 300 comprises a speaker 250, a rigid structure 230, a heat exchanger 220 mounted to a heat exchanger mounting 310, and a fan 120.

Over time, dust 320 may accumulate on grating 130 or on blades 330 of heat exchanger 220. Buildup of dust 320 may be problematic on grating 130 of enclosure 110, or on blades 330 of heat exchanger 220. It will also be recognized that dust accumulation may occur in other places where airflow 140 may be impeded by dust 320. Thus, it is intended for this Specification to encompass all such applications.

In an example, speaker 250 is configured to drive an audible acoustic signal into ambient environment 150. This may be, for example, to provide music or other audio signals to a user of computer 100. However, when speaker 250 is mounted to a rigid structure 230, when speaker 250 drives and acoustic signal into ambient environment 150, a corresponding mechanical waveform is driven onto rigid structure 230. Thus, it is possible to use a component that is commonly found in laptop computers, such as speaker 250, to drive a useful mechanical waveform onto rigid structure 230. Rigid structure 230 may be mechanically coupled to heat exchanger mounting 310. The mechanical coupling of the present Specification may include, by way of non-limiting example, mounting a speaker 250 onto rigid structure 230, directly onto heat exchanger 220, onto motherboard 210, or mechanically coupling a speaker 250 to heat exchanger 220 in any way such that at least a portion of an acoustic energy provided by speaker 250 is translated into a mechanical waveform on heat exchanger 220. The mechanical waveform may drive heat exchanger 220 to vibrate sufficiently to dislodge dust and other particle debris from heat exchanger 220, or to perform other useful work.

In one example, rigid structure 230 and heat exchanger mounting 310 are both thin strips of metal. In other examples, however, other materials may be used. Furthermore, it is not necessary that rigid structure 230 be strictly rigid. Rigid structure 230 could be a fluid or semi-fluid substance, according to certain design parameters, which may be also useful for transmitting an acoustic signal from speaker 250 into a mechanical waveform on heat exchanger mounting 310. Furthermore, in other examples, heat exchanger mounting 310 may be one and the same with rigid structure 230. In other words, speaker 250 may be mounted directly onto heat exchanger mounting 310.

As a practical consideration, rigid structure 230 will have a limit to its length and other dimensions. For example, if speaker 250 is too far away from heat exchanger mounting 310, or if rigid structure 230 is either too stiff or too springy, acoustic signals from speaker 250 may but may not be usefully translated into mechanical waveforms on heat exchanger mounting 310. Those with skill in the art will have the ability to design a rigid structure 230 according to the parameters and limitations of a specific host configuration. In one example, rigid structure 230 may be made of the types of metal plating commonly used in laptop computers, including for example copper, steel, and aluminum. Use of such common materials may enable speaker 250 to be usefully placed essentially anywhere within an enclosure 120 of a common laptop computer.

In certain examples, an initial frequency may be selected based on calculated physical parameters of speaker 250, rigid structure 230, heat exchanger 220, and heat exchanger mounting 310. These calculations may provide a useful starting point for an operable frequency. However, because each of these is a nonideal structure, and may include irregularities and other imperfections, it is useful to provide a configurable operable frequency for speaker 250. This may be accomplished, for example, by using speaker 250 to perform a frequency sweep with an operable resolution across a range of frequencies selected around the initial starting frequency.

As the frequency sweep is performed, existing sensors within computer 100 may be used to detect vibration. For example, many laptop computers include existing accelerometers to detect drop events or other types of inputs. Because rigid structure 230 may be mechanically mounted to motherboard 210, collateral vibrations may be induced across motherboard 210. Accelerometers 370 mounted on motherboard 210 may be used to detect this acceleration. The acceleration at an accelerometer 370 mounted to motherboard 210 may be of a different magnitude from the actual waveform imposed on heat exchanger 220. However, the purpose of a frequency sweep may be simply to identify a maximum vibration magnitude, without reference necessarily to the specific magnitude of the vibration. Thus, in one example, accelerometer 370 mounted to motherboard 210 experiences a vibration that is smaller in magnitude than the vibration experienced by heat exchanger 220 and heat exchanger mounting 310. However, readings from accelerometer 370 are still useful for identifying a local maximum vibration imposed by speaker 250.

In one example, a resonant frequency of sonic dust remediation system 300 may be selected to provide an optimal balance between power input to sonic dust remediation system 300 via speaker 250 and maximum removal of dust 320. It should be recognized, however, that a resonant frequency is provided by way of example only, and need not be provided in every case. Indeed, in some cases, a resonant frequency may provide too much vibration, which may create problems for motherboard 210 and other components of computer 100. Thus, a true resonant frequency may not be desirable in those cases. In that case, an operable frequency somewhat offset from a true resonant frequency may be selected to avoid excessive vibration that may damage complements. Those with skill in the art will recognize the need and will have the ability to select a frequency to provide a vibration magnitude that is operable to remove dust 320 without damaging motherboard 210 and components mounted thereto.

FIG. 4 is a block diagram of computer 100 according to one or more examples of the present Specification. Computer 100 includes a processor 410 connected to a memory 420, having stored therein executable instructions for providing a maintenance daemon 422. Processor 410 is communicatively coupled to other devices via a bus 470. As used throughout this Specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

Other devices include a storage 450, speakers 250, peripherals 460, and power supply 480. Processor 410 and speaker 250 are also mechanically coupled to heat exchanger 220 via rigid structure 230.

Power supply 480 may distribute power to system devices via bus 470, or via a separate power bus. Fan 120 also receives power from power supply 480, and may be controlled by processor 410 via bus 470.

In this example, processor 410 may be any combination of hardware, software, or firmware providing programmable logic, including by way of non-limiting example a microprocessor, digital signal processor, field-programmable gate array, programmable logic array, application-specific integrated circuit, or virtual machine processor.

Processor 410 is shown connected to memory 420 in a direct memory access (DMA) configuration via DMA bus 412. By way of example, memory 420 is disclosed as a single logical block, and may include any suitable volatile or non-volatile memory technology, including DDR RAM, SRAM, DRAM, flash, ROM, optical media, virtual memory regions, magnetic or tape memory, or any other suitable technology. In certain embodiments, memory 420 may be a relatively low-latency volatile main memory, while storage 450 may be a relatively higher-latency non-volatile memory. However, memory 420 and storage 450 need not be physically separate devices, and in some examples may represent simply a logical separation of function. It should also be noted that although DMA is disclosed by way of non-limiting example, DMA is not the only protocol consistent with this Specification, and that other memory architectures are available. Thus, DMA bus 412 is provided by way of example only. Storage 450 may be a species of memory 420, or may be a separate device, such as a hard drive, solid-state drive, external storage, redundant array of independent disks (RAID), network-attached storage, optical storage, tape drive, backup system, cloud storage, or any combination of the foregoing. Storage 450 may be, or may include therein, a database or databases or data stored in other configurations, and may include a stored copy of operational software such as an operating system and a copy of maintenance daemon 422. Many other configurations are also possible, and are intended to be encompassed within the broad scope of this Specification.

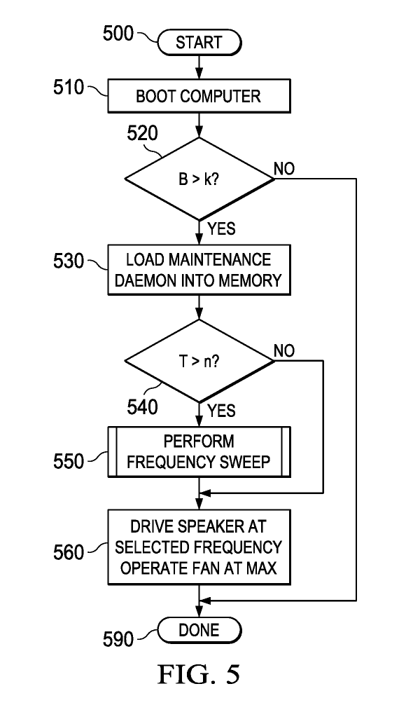

Maintenance daemon 422, in one example, is a utility or program that carries out a method, such as method 500 of FIG. 5, or other methods according to this Specification. A “daemon” may include any program or series of executable instructions, whether implemented in hardware, software, firmware, or any combination thereof, that runs as a background process, a terminate-and-stay-resident program, a service, system extension, control panel, bootup procedure, BIOS subroutine, or any similar program that operates without direct user interaction. It should also be noted that maintenance daemon 422 is provided by way of non-limiting example only, and that other software, including interactive or user-mode software, may also be provided in conjunction with, in addition to, or instead of maintenance daemon 422 to perform methods according to this Specification.

In one example, maintenance daemon 422 includes executable instructions stored on a non-transitory medium operable to perform method 500 of FIG. 5, or a similar method according to this Specification. At an appropriate time, such as upon booting computer 100, processor 410 may retrieve a copy of maintenance daemon 422 from storage 450 and load it into memory 420. Processor 410 may then iteratively execute the instructions of maintenance daemon 422.

FIG. 5 is a flow chart of an example method 500 of performing sonic dust removal according to one or more examples of the present Specification. It should be noted that this method is provided by way of example only, and is not intended to be limiting. According to method 500, in block 510, computer 100 boots. For example, computer 100 may change from a powered-off state to a powered-on state, and perform a normal boot procedure, including for example a power-on-self-test (POST). In one example, method 500 is performed after the POST, but before an operating system is loaded into memory 420.

In block 520, the value B represents the number of times computer 100 has been booted since the last sonic dust removal. The value k represents, for example, a constant representing the maximum number of boot cycles between sonic dust removal cycles. Thus, block 520 comprises the comparison “B>k?” If this comparison is false, then control passes to block 590 and method 500 is done. If the comparison is true, then control passes to block 530 and the method continues. It should be noted that the representation of B and k as simple numeric boot cycles is provided by way of non-limiting example only. Evidently, B and k can represent any suitable method for determining a time span between sonic dust removal cycles. For example, the schedule for performing sonic dust removal may be based on a time span rather than a number of boot cycles, for example, performing the procedure once a week. In another example, airflow sensors within ducting 260 may be used to keep a hysteretic table of airflow, and detect when airflow becomes more than k % obstructed, where k may be, for example, approximately 10%. In other examples, a combination of factors may be used. For example, sonic dust removal could be run every 10 boot cycles, once every week, or whenever ducting 260 becomes more than 10% blocked, whichever is soonest.

It should also be noted that method 500 need not necessarily be performed at bootup. Maintenance daemon 422 may instead be a background process running under an operating system, and may, for example, perform method 500 at off-peak operating times or at other useful times. Advantageously, if method 500 is performed at bootup, either at every bootup or at every kth boot cycle where k>1, interference with user operations may be minimized.

In block 530, computer 100 has determined that sonic dust removal must be run, and loads maintenance daemon 422 into memory. This may include, for example, retrieving a stored copy of maintenance daemon 422 from storage 450 and copying it into memory 420. Again, it should be noted that maintenance daemon 422 may be a BIOS procedure in some cases, while in other cases it may be an operating system daemon or process.

In block 540, another comparison is made, namely “T<n?” In this case, T may represent the number of sonic dust removal cycles since the last frequency sweep, and n may represent a numerical constant set as the maximum number of sonic dust removal cycles between frequency sweeps. As with the comparison of block 520, this comparison need not be an exact or single numerical comparison. In some embodiments, the comparison may involve an absolute time value, a number of boot cycles, or may be based on feedback from sensors such as airflow sensors. Furthermore, block 540 may represent a combination of factors as discussed above in relation to block 520. If the test of block 540 is false, then control passes to block 560. If it is true, then control passes to block 550.

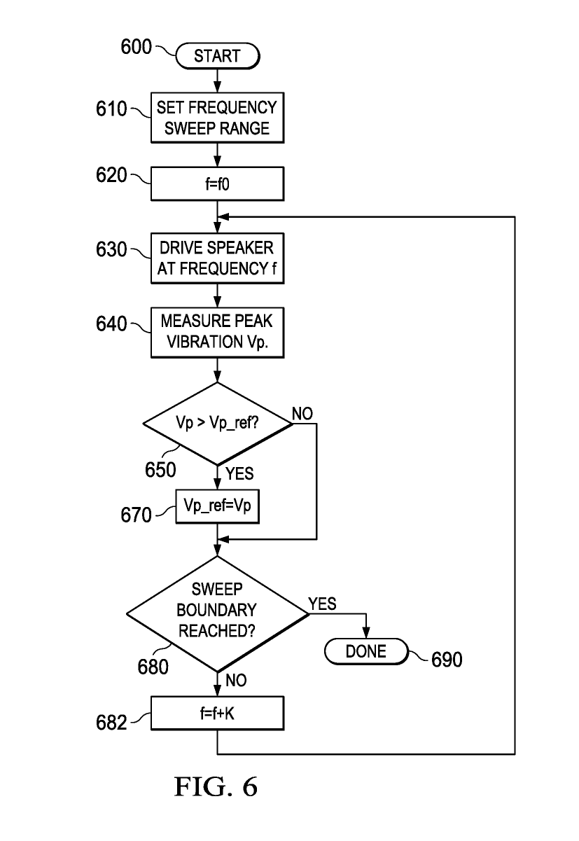

Block 550 is a metablock in which a frequency sweep is performed to identify an optimal frequency for sonic dust removal. This method is described with more detail in connection with FIG. 6.

Block 560 represents the act of actual sonic dust removal. In block 560, processor 410 drives speaker 250 at a selected frequency for a selected time to impose on heat exchanger 220 a mechanical waveform. During this time, fan 120 may also be operated at its maximum output to propel dislodged dust 320 away from heat exchanger 220 and through grating 130.

After a sufficient time, speaker 250 may be powered down, and in block 590 the method is done.

FIG. 6 is a block diagram of an example method 600 of performing a frequency sweep according to one or more examples of the present Specification. As noted above, FIG. 6 may be performed by or may be a subroutine of block 550 of FIG. 5.

In block 610, processor 410 sets an appropriate frequency sweep range and resolution. For example, if the currently selected frequency f₀ is 1 kHz, processor 410 may be programmed to perform a sweep over a range of 20% of f₀, with a total of ten steps. It should be noted, however, that this is provided by way of example only, and is not intended to be limiting. In the 10-step, 20% example, processor 410 may populate an array in memory 420 with the following values:

| f[0] | f[1] | f[2] | f[3] | f[4] | f[5] | f[6] | f[7] | f[8] | f[9] |
|---|---|---|---|---|---|---|---|---|---|
| 920 | 940 | 960 | 980 | 1000 | 1020 | 1040 | 1060 | 1080 | 1100 |

The selection of the range and resolution of this array depends, in individual cases, on design parameters of the specific system, including for example the structural integrity and sensitivity of computer 100. In some designs with low sensitivity, a coarse frequency sweep may be adequate, and in some cases may even be more desirable, as true resonance may not be optimal. It should be noted that method 600 need not necessarily be a search for an exact resonant frequency. Depending on design parameters, an off-peak frequency may be optimal to avoid overdriving vibrations on heat exchanger 220 or on motherboard 210, where there may be danger of causing structural damage.

In block 620, fₜ=f₀, meaning that the test frequency for the first pass is set to the currently selected frequency.

In block 630, speaker 250 is used to drive test frequency fₜ onto rigid structure 230. The magnitude of the vibration may be selected according to design parameters and system performance, as may the time for driving frequency fₜ onto rigid structure 230. In some cases, the drive time for each frequency step may not be very long. Often, a drive time of one second or less is sufficient to provide a useful peak vibration measurement. It may be beneficial to inversely relate the drive time to the granularity of the frequency sweep. In cases where a coarse granularity is used, a longer drive time of a full second or more may be used. In cases where a finer-grained sweep is used, a shorter drive time may be used, such that a continuous-time analog frequency sweep is approximated. This latter case may approximate a continuous-time Fourier analysis of frequency characteristics. In that case, a reverse Fourier transform may be used to construct a time-domain model of the system, which may be used to select a suitable drive magnitude and drive time for sonic dust removal according to method 500 of FIG. 5.

In block 640, peak vibration Vₚ is measured for test frequency fₜ. Block 640 may also include a built-in safety measure. For example, if Vₚ exceeds a threshold, speaker 250 may be immediately powered down to avoid damage to the system.

In decision block 650, processor 410 checks whether Vₚ>Vₚ_{_{ref}}, wherein Vₚ_{_{ref}} represents a previously stored peak vibration value. If the test is true, then in block 670, processor 410 overwrites Vₚ_{_{ref}} with Vₚ, meaning that fₜ is provisionally selected as the new value for f₀. There may also be a safety measure built into this step. For example, fₜ may not be selected as the new proposed value of f₀ if Vₚ exceeds a threshold value. This may ensure that the system is not overdriven and damaged.

Control then passes to block 680, either from block 670, or directly from block 650. Block 680 is a decision block that checks whether the upper boundary of the frequency sweep has been reached. If it hasn't, then in block 682, fₜ is incremented to the next value in the array and control passes back to block 630 to test the new fₜ. If the boundary has been reached, then in block 690 the method is done.

Experimental prototype results have demonstrated the effectiveness of the system and method of the present Specification. In one test example, a laptop computer was prepared substantially according to FIG. 2. The computer was operated with the Intel® Thermal Analysis Toolkit™ (TAT), which is specifically designed for measuring CPU stress. The test system was first operated at TAT 100% for 2 hours at an ambient temperature of 23°-25° C. The test system was then placed in a dust chamber at approximately 23°-25° C. for 72 hours, and again operated at TAT 100% for the duration. The test system was then removed from the dust chamber and operated at TAT 100% for two hours. Next, a test tone of 1 kHZ was driven on one speaker for 60 seconds every 30 minutes during the final test, in which the test system was operated at TAT 100% for two hours. Before and after testing of CPU temperature, top skin temperature, bottom skin temperature, and system noise yielded the following results.

| | | | After Test | | | |
|---|---|---|---|---|---|---|
| | | | With Sonic | | Without Sonic | |
| Test Parameter | Before Test | | Vibration | | Vibration | |
| CPU Temperature | 82° | C. | 86° | C. | >98° C., CPU | |
| | | | | | throttling | |
| Top Skin | 46° | C. | 48° | C. | 53° | C. |
| Temperature | | | | | | |
| Bottom Skin | 47° | C. | 49.5° | C. | 55° | C. |
| temperature | | | | | | |
| System Noise | 39 | dBA | 39 | dBA | 42 | dBA |

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips.

In example implementations, at least some portions of the processing activities outlined herein may also be implemented in software. In some embodiments, one or more of these features may be implemented in hardware provided external to the elements of the disclosed figures, or consolidated in any appropriate manner to achieve the intended functionality. The various components may include software (or reciprocating software) that can coordinate in order to achieve the operations as outlined herein. In still other embodiments, these elements may include any suitable algorithms, hardware, software, components, modules, interfaces, or objects that facilitate the operations thereof.

Additionally, some of the components associated with described microprocessors may be removed, or otherwise consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’ Similarly, any of the potential processing elements, modules, and machines described herein should be construed as being encompassed within the broad term ‘microprocessor’ or ‘processor.’ Furthermore, in various embodiments, the processors, memories, network cards, buses, storage devices, related peripherals, and other hardware elements described herein may be realized by a processor, memory, and other related devices configured by software or firmware to emulate or virtualize the functions of those hardware elements.

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In the discussions of the embodiments above, the capacitors, buffers, graphics elements, interconnect boards, clocks, DDRs, camera sensors, dividers, inductors, resistors, amplifiers, switches, digital core, transistors, and/or other components can readily be replaced, substituted, or otherwise modified in order to accommodate particular circuitry needs. Moreover, it should be noted that the use of complementary electronic devices, hardware, non-transitory software, etc. offer an equally viable option for implementing the teachings of the present disclosure.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another example embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended Claims. In order to assist the United States Patent and Trademark Office (USPTO) and, additionally, any readers of any patent issued on this application in interpreting the Claims appended hereto, Applicant wishes to note that the Applicant: (a) does not intend any of the appended Claims to invoke paragraph six (6) of 35 U.S.C. section 112 as it exists on the date of the filing hereof unless the words “means for” or “steps for” are specifically used in the particular Claims; and (b) does not intend, by any statement in the Specification, to limit this disclosure in any way that is not otherwise reflected in the appended Claims.

### Example Embodiment Implementations

There is disclosed in example 1, an apparatus, comprising:
an acoustic driver mechanically coupled to a heat exchanger, wherein the mechanical coupling is disposed so that at least a portion of an acoustical energy provided by the acoustic driver is at least partly translated to a mechanical waveform on the heat exchanger.

There is disclosed in example 2, the apparatus of example 1, further comprising logic, at least partly implemented in hardware, to select one or more drive frequencies for the acoustic driver.

There is disclosed in example 3, the apparatus of example 2, wherein the one or more drive frequencies comprise substantially a resonant frequency of the heat exchanger.

There is disclosed in example 4, the apparatus of example 1, further comprising logic, at least partly implemented in hardware, to operate a fan while the energy provided by the mechanical driver is at least partly translated to a mechanical waveform on the heat exchanger.

There is disclosed in example 5, the apparatus of example 1, further comprising:
one or more sensors to sense the mechanical waveform of the heat exchanger; and logic, at least partly implemented in hardware, to receive a feedback signal from the one or more sensors and to adjust at least one frequency of the acoustical energy responsive to the feedback signal.

There is disclosed in example 6, the apparatus of example 5, further comprising logic, at least partly implemented in hardware, to perform a frequency sweep across a plurality of frequencies and to select from the frequency sweep a frequency for driving the acoustic driver.

There is disclosed in example 7, the apparatus of example 1, further comprising an acoustic energy transfer element disposed to translate at least part of the acoustical energy provided by the acoustic driver to the mechanical waveform on the heat exchanger.

There is disclosed in example 8, a system, comprising: an acoustic driver;
a heat exchanger mechanically coupled to the acoustic driver, wherein the mechanical coupling is disposed so that at least a portion of an acoustical energy provided by the acoustic driver is at least partly translated to a mechanical waveform on the heat exchanger; and
logic, at least partly implemented in hardware, to select one or more drive frequencies for the acoustic driver.

There is disclosed in example 9, the system of example 8, further comprising a processor and memory, wherein the logic is at least partly encoded in the processor and memory.

There is disclosed in example 10, the system of example 8, wherein the selected frequency comprises substantially a resonant frequency of the heat exchanger.

There is disclosed in example 11, the system of example 8, further comprising a fan, and logic, at least partly implemented in hardware, to operate the fan while driving the acoustic driver at the selected frequency.

There is disclosed in example 12, the system of example 8, further comprising:
one or more sensors to sense the mechanical waveform of the heat exchanger; and
logic, at least partly implemented in hardware, to receive a feedback signal from the one or more sensors and to adjust the selected frequency responsive to the feedback signal.

There is disclosed in example 13, the system of example 12, further comprising logic, at least partly implemented in hardware, to perform a frequency sweep across a plurality of frequencies and to select at least one of the plurality of frequencies as the selected frequency.

There is disclosed in example 14, the apparatus of example 8, further comprising an acoustic energy transfer element disposed to translate at least part of the acoustical energy provided by the acoustic driver to the mechanical waveform on the heat exchanger.

There is disclosed in example 15, an apparatus, comprising:
logic, at least partly implemented in hardware, to cause an acoustic driver to drive a selected frequency to drive a mechanical waveform onto a heat exchanger, wherein the heat exchanger is mechanically coupled to the acoustic driver.

There is disclosed in example 16, the apparatus of example 15, further comprising a processor and memory, wherein the logic is at least partly encoded in the processor and memory.

There is disclosed in example 17, the apparatus of example 15, wherein the selected frequency comprises substantially a resonant frequency of the heat exchanger.

There is disclosed in example 18, the apparatus of example 15, further comprising a fan, and logic, at least partly implemented in hardware, to operate the fan while driving the acoustic driver at the selected frequency.

There is disclosed in example 19, the apparatus of example 15, further comprising:
one or more sensors to sense the mechanical waveform of the heat exchanger; and
logic, at least partly implemented in hardware, to receive a feedback signal from the one or more sensors and to adjust the selected frequency responsive to the feedback signal.

There is disclosed in example 20, the apparatus of example 19, further comprising logic, at least partly implemented in hardware, to perform a frequency sweep across a plurality of frequencies and to select at least one of the plurality of frequencies as the selected frequency.

There is disclosed in example 21, the apparatus of example 15, further comprising an acoustic energy transfer element disposed to translate at least part of the acoustical energy provided by the acoustic driver to the mechanical waveform on the heat exchanger.

There is disclosed in example 22, one or more non-transitory computer-readable mediums having encoded thereon logic to:
cause an acoustic driver to drive a selected frequency to drive a mechanical waveform onto a heat exchanger, wherein the heat exchanger is mechanically coupled to the acoustic driver.

There is disclosed in example 23, the one or more non-transitory computer-readable mediums of example 22, wherein the selected frequency comprises substantially a resonant frequency of the heat exchanger.

There is disclosed in example 24, the one or more non-transitory computer-readable mediums of example 22, further comprising logic to operate a fan while driving the acoustic driver at the selected frequency.

There is disclosed in example 25, the one or more non-transitory computer-readable mediums of example 22, further comprising logic to receive a feedback signal from one or more sensors and to adjust the selected frequency responsive to the feedback signal.

There is disclosed in example 26, the one or more non-transitory computer-readable mediums of example 25, further comprising logic to perform a frequency sweep across a plurality of frequencies and to select at least one of the plurality of frequencies as the selected frequency.

1-26. (canceled)

27. An apparatus, comprising:
an acoustic driver mechanically coupled to a heat exchanger, wherein the mechanical coupling is disposed so that at least a portion of an acoustical energy provided by the acoustic driver is at least partly translated to a mechanical waveform on the heat exchanger.

28. The apparatus of claim 27, further comprising logic, at least partly implemented in hardware, to select one or more drive frequencies for the acoustic driver.

29. The apparatus of claim 28, wherein the one or more drive frequencies comprise substantially a resonant frequency of the heat exchanger.

30. The apparatus of claim 27, further comprising logic, at least partly implemented in hardware, to operate a fan while the energy provided by the mechanical driver is at least partly translated to a mechanical waveform on the heat exchanger.

31. The apparatus of claim 27, further comprising:
one or more sensors to sense the mechanical waveform of the heat exchanger; and
logic, at least partly implemented in hardware, to receive a feedback signal from the one or more sensors and to adjust at least one frequency of the acoustical energy responsive to the feedback signal.

32. The apparatus of claim 31, further comprising logic, at least partly implemented in hardware, to perform a frequency sweep across a plurality of frequencies and to select from the frequency sweep a frequency for driving the acoustic driver.

33. The apparatus of claim 27, further comprising an acoustic energy transfer element disposed to translate at least part of the acoustical energy provided by the acoustic driver to the mechanical waveform on the heat exchanger.

34. A system, comprising:
an acoustic driver;
a heat exchanger mechanically coupled to the acoustic driver, wherein the mechanical coupling is disposed so that at least a portion of an acoustical energy provided by the acoustic driver is at least partly translated to a mechanical waveform on the heat exchanger; and
logic, at least partly implemented in hardware, to select one or more drive frequencies for the acoustic driver.

35. The system of claim 34, further comprising a processor and memory, wherein the logic is at least partly encoded in the processor and memory.

36. The system of claim 34, wherein the selected frequency comprises substantially a resonant frequency of the heat exchanger.

37. The system of claim 34, further comprising a fan, and logic, at least partly implemented in hardware, to operate the fan while driving the acoustic driver at the selected frequency.

38. The system of claim 34, further comprising:
one or more sensors to sense the mechanical waveform of the heat exchanger; and
logic, at least partly implemented in hardware, to receive a feedback signal from the one or more sensors and to adjust the selected frequency responsive to the feedback signal.

39. The system of claim 38, further comprising logic, at least partly implemented in hardware, to perform a frequency sweep across a plurality of frequencies and to select at least one of the plurality of frequencies as the selected frequency.

40. The apparatus of claim 34, further comprising an acoustic energy transfer element disposed to translate at least part of the acoustical energy provided by the acoustic driver to the mechanical waveform on the heat exchanger.

41. An apparatus, comprising:
logic, at least partly implemented in hardware, to cause an acoustic driver to drive a selected frequency to drive a mechanical waveform onto a heat exchanger, wherein the heat exchanger is mechanically coupled to the acoustic driver.

42. The apparatus of claim 41, further comprising a processor and memory, wherein the logic is at least partly encoded in the processor and memory.

43. The apparatus of claim 41, wherein the selected frequency comprises substantially a resonant frequency of the heat exchanger.

44. The apparatus of claim 41, further comprising a fan, and logic, at least partly implemented in hardware, to operate the fan while driving the acoustic driver at the selected frequency.

45. The apparatus of claim 41, further comprising:
one or more sensors to sense the mechanical waveform of the heat exchanger; and
logic, at least partly implemented in hardware, to receive a feedback signal from the one or more sensors and to adjust the selected frequency responsive to the feedback signal.

46. The apparatus of claim 45, further comprising logic, at least partly implemented in hardware, to perform a frequency sweep across a plurality of frequencies and to select at least one of the plurality of frequencies as the selected frequency.

47. The apparatus of claim 41, further comprising an acoustic energy transfer element disposed to translate at least part of the acoustical energy provided by the acoustic driver to the mechanical waveform on the heat exchanger.

48. One or more non-transitory computer-readable mediums having encoded thereon logic to:
cause an acoustic driver to drive a selected frequency to drive a mechanical waveform onto a heat exchanger, wherein the heat exchanger is mechanically coupled to the acoustic driver.

49. The one or more non-transitory computer-readable mediums of claim 48, wherein the selected frequency comprises substantially a resonant frequency of the heat exchanger.

50. The one or more non-transitory computer-readable mediums of claim 48, further comprising logic to operate a fan while driving the acoustic driver at the selected frequency.

51. The one or more non-transitory computer-readable mediums of claim 48, further comprising logic to receive a feedback signal from one or more sensors and to adjust the selected frequency responsive to the feedback signal.

52. The one or more non-transitory computer-readable mediums of claim 51, further comprising logic to perform a frequency sweep across a plurality of frequencies and to select at least one of the plurality of frequencies as the selected frequency.
